(19) United States
(12) Patent Application Publication
(10) Pub. No.: US 2008/0197265 A1
(43) Pub. Date: Aug. 21, 2008

(54) Systems for Constructing Sand Structures

(76) Inventor: Gerald Taufield, Tenafly, NJ (US)

Correspondence Address: GIBBONS P.C., ONE GATEWAY CENTER, NEWARK, NJ, 07102, US

(21) Appl. No.: 11/675,288

(22) Filed: Feb. 15, 2007

(51) Int. Cl. B41B 11/54

(52) U.S. Cl. 249/160

(57) ABSTRACT

Systems for constructing sand structures. The system comprises one or more sand molds that can be filled with sand in order to construct a sand structure. One or more void blocks are positionable within one or more sand molds to create a special shaped void in the packed sand to increase the versatility and configurations of the sand structure. There may be a plurality of sand moles stackable upon each other in order to construct tiered structures in a desired shape and the edges of the multiple sand molds can include an alignment system that affixes the sand molds together as they are progressively filled with sand. Once filled, the molds are removed, thus creating the sand structure. A package contains all of the sand molds and void blocks necessary to construct various sand structures and may include weapons used to destroy a completed sand structure in playing a game.

### FIELD OF THE INVENTION

The present invention relates to systems for constructing structures and, more particularly, to systems utilizing one or more molds that are filled with a material to create a unique structure.

### BACKGROUND OF THE INVENTION

One of the common and entertaining activities carried out at a beach is the construction of structures made up of compacted sand. Obviously, the structures ran from the construction of rudimentary structures by children using only a shovel or simple tools to extremely difficult structures that are complex and produced by highly skilled persons.

There is also a time constraint on the construction of sand structures since most of the structures are produced on the beach by persons there for the day and therefore the structure must be finished within a relatively short period of time within daylight hours and prior to the onslaught of the tide that will eventually wash the structure away. As such, it is difficult for one having normal skill level to construct a solid, good appearing structure fairly quickly and with good results.

It would therefore be advantageous to have better tools to enable a person at the beach to construct good structures fairly rapidly and with good appearance of the structure. It would be further advantageous to be able to use such tool to enable a child to make a game out of constructing the sand structure with enthusiasm and make the day pleasant for the child.

### SUMMARY OF THE INVENTION

Accordingly, the present invention relates to systems for producing structures that can be used by one having minimum skill in building structures and yet produce a structure having a good appearance in a relatively short period of time. In the exemplary embodiment of the present invention, the invention will be described with respect to sand molds and the construction of sand structures, however, it will be seen that the present invention is applicable to other materials, including, but not limited to, edible materials, latex, snow, wax and the like.

In one exemplary embodiment of the invention, there is provided the tools necessary to produce a sand structure and which can include at least one sand mold that can be placed on the ground and filled with sand to create a particular shaped sand structure. In connection with a sand mold, there may be one or more void blocks that can be positioned at or near the lower edge or edges of one or more sand molds as a sand mold is being filled with sand, thereby creating one or more voids in the ultimate sand structure. The void or voids allows the user to create a wider variety of sand structures and still be able to remove the sand mold or mold when the structure is completed.

In another exemplary embodiment of the invention, there may be at least two sand molds, one of which can be placed on the ground and the other placed atop of the first sand mold after that first sand mold has been filled with sand. Thus, the second sand mold is then packed with sand such that the eventual sand structure is in the shape of a combination of the at least two sand molds. There may, of course, be more than two sand molds and they may be of a wide variety of differing shapes and sizes.

In an aforementioned embodiment, the lower edge of an upper sand mold can be aligned or affixed to the upper edge of the next lower sand mold and, with more than two sand molds, additional sand molds can be affixed together and progressively filled with sand such that, when all of the sand molds have been filled, all of the sand molds can be removed by simply vertically lifting the sand molds off of the sand structure.

There may also be one or more objects that are placed within or at least partially within one or more molds as the sand is being packed into that mold so that the object can be searched for when the sand structure is completed or the object can create the formation of a tunnel or other passageway within that sand structure.

These and other features and advantages of the present invention will become more readily apparent during the following detailed description taken in conjunction with the drawings herein.

### BRIEF DESCRIPTION OF THE DRAWINGS

FIG. 1 is a perspective view of a sand mold constructed in accordance with the present invention;

FIG. 2 is a perspective view of a plurality of sand molds with one stacked atop of the other;

FIG. 3 is a perspective view of a plurality of sand molds and illustrating three sand molds stacked together;

FIG. 4 is a perspective view of a plurality of sand molds stacked together in the completed stage of constructing a sand structure;

FIG. 5 is a perspective view of a sand structure resulting from the steps illustrated in FIG. 1-4 with the sand molds removed;

FIG. 6 is an exploded view illustrating an exemplary system to affix one sand mold to another sand mold;

FIGS. 7 and 7A are exploded views illustrating alternate systems to that of FIG. 6 to align one sand mold to another sand mold;

FIGS. 8A-8G are schematic views of various embodiments of the present invention;

FIG. 9 is an exploded view of an exemplary embodiment of the present invention utilizing a void block;

FIG. 10 is a perspective view of the FIG. 9 embodiment with a void block located within a sand mold;

FIG. 11 is a perspective view of the FIG. 9 embodiment with the sand mold removed but with the void block in place in the sand structure;

FIG. 12 is a perspective view of the FIG. 9 embodiment with the void block removed from the sand structure;

FIG. 13 is a schematic view of an alternate embodiment of the present invention;

FIG. 14 is a schematic view of a further alternate embodiment of the present invention;

FIG. 15 is a schematic view of a still further alternate embodiment of the present invention;

FIGS. 16A-16E are schematic views of various embodiments of the present invention constructed with the use of void blocks;

FIGS. 17A-C are schematic views showing certain molds with and without void blocks for various structures the can be constructed with the present invention;

FIGS. 18A-18C are schematic views of the structures of FIGS. 17A-17C with the void blocks removed;

FIGS. 19A-19C are schematic views of various weapons that can be used with the present invention; and

FIGS. 20A-20C are schematic views illustrating users playing a game using the structures of FIGS. 19A-19C

### DETAILED DESCRIPTION OF THE INVENTION

Referring now to FIG. 1, there is shown a perspective view of an exemplary sand mold 20 constructed in accordance with the present invention. As can be seen, the sand mold 20 is adapted to rest on the ground in order to carry out the present invention and the ground will normally be a beach where unlimited sand is available, however, the invention could be employed at other sites, such as a sand box at a playground or yard.

In the exemplary embodiment of FIG. 1, the sand mold 20 is configured to construct a pyramidal shaped structure, however, as will be seen, many other shapes and sizes of sand structures can be constructed in accordance with this invention. As can be seen in FIG. 1, the sand mold 20 comprises a rim 22 having an upper edge 24 and a lower edge 26, the latter of course, resting on the ground with an open area 28 formed within the rim 22. Due to the particular shape of the FIG. 1 embodiment i.e. a pyramid, the perimeter of the upper edge 24 is smaller than the perimeter of the lower edge 26 such that the rim 22 slopes outwardly in the downward direction. The sand mold 20 can be made of a metal, ceramic, plastic or any other suitable material having sufficient strength to carry out the purpose of this invention. Rim 22 can be a one piece construction or may be a plurality of individual components that are affixed together to make up the rim 22 as shown in FIG. 1.

To carry out the first step of the method aspect of the present invention, therefore, the sand mold 20 is placed on the ground and filled with sand, preferable wet sand having a consistency to form sand structures. The sand mold 20 may have a lower flange that flares out from the lower edge 26 to prevent the sand mold 20 from digging in the sand. As also can be seen in FIG. 1, there may be an object 30 that is buried in the sand as that sand is packed into the sand mold 20 to conceal the object 30 in accordance with a game that can be played along with the constructing of the sand structure. There may, of course, be more than one object 30 placed with a mold and the object 30 can be of a wide variety of shapes. Thus, once introduced into a mold and buried within the sand packed within the mold, a player can make a game out of trying to locate the object or objects within a single tier or multiple tiers of the sand structure.

An object may also be a hollow object so as to form a tunnel with the ultimate sand structure is completed and the object can be completely concealed within the sand or may extend outwardly to the inner edge of the sand mold 20 so that a tunnel can be seen when the sand mold 20 is removed as will be later illustrated. As will also later become clear, the object 30 can be located in any one or more of the tiers of a multiple tiered sand structure constituted using the present invention.

As such, with the particular sand mold 20 in the shape as illustrated in FIG. 1, when the sand is packed therein up to the level of the upper edge 24, the sand will take the shape of the sand mold 20 and be a truncated pyramid shape.

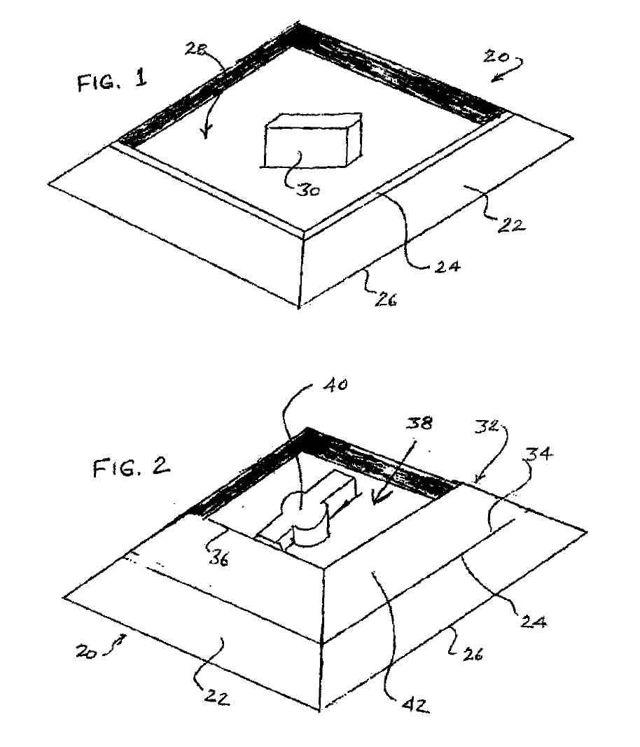

Turning next to FIG. 2, there is shown, a perspective view of the sand mold 20 of FIG. 1 having a further or second sand mold 32 resting atop of the sand mold 20. As can be seen, when the upper, second sand mold 32 is resting on the lower, first sand mold 20, the lower edge 34 of the sand mold 32 is resting upon and generally contiguous to the upper edge 24 of the sand mold 20. In an exemplary embodiment, that lower edge 34 of the second sand mold 32 is aligned with the upper edge 24 of the sand mold 20 in a manner that will be later explained. Since the upper edge 36 of the second sand mold 32 is open, again, the wet sand can be packed into the open area 38 to fill up that open area 38 up to the level of the upper edge 36.

As with FIG. 1 an object 40 can be inserted into the second tier of the sand structure being constructed by filling the second sand mold 32 and/or some device can be added that forms a tunnel, secret room or the like.

As with the sand mold 20, the second sand mold 32, being configured to form a pyramid, has the perimeter of its upper edge 36 smaller an the perimeter of its lower edge 34 and the rim 42 is generally formed at the same angle with respect to the horizontal as the angle of the rim 22 of the sand mold 20.

Turning to FIG. 3, there is shown a perspective view of a still further, third sand mold 44 positioned atop of the second sand mold 32 and, again, the lower edge 46 of the rim 48 of the third sand mold 44 rests on, is supported by and is generally contiguous to the upper edge 36 of the second sand mold 32. Again, the upper edge 50 of third sand mold 44 has a perimeter that is smaller than the perimeter of its lower edge 46 and an open area 52 is formed therein to be filled by the user with wet sand up to the upper edge 50 of the third sand mold 44.

As can now be appreciated, by progressively filling the sand molds 20, 32 and 44 with wet sand, the user has created tiers of the sand structure in the shape of a pyramid having a generally uniform outer angle with respect to the horizontal. As also can be seen, while three sand molds have been illustrated, there may be a greater or a lesser number of sand molds and tiers created and used in constructing a particular sand structure having a wide variety of differing shapes and configurations as is desired by the user.

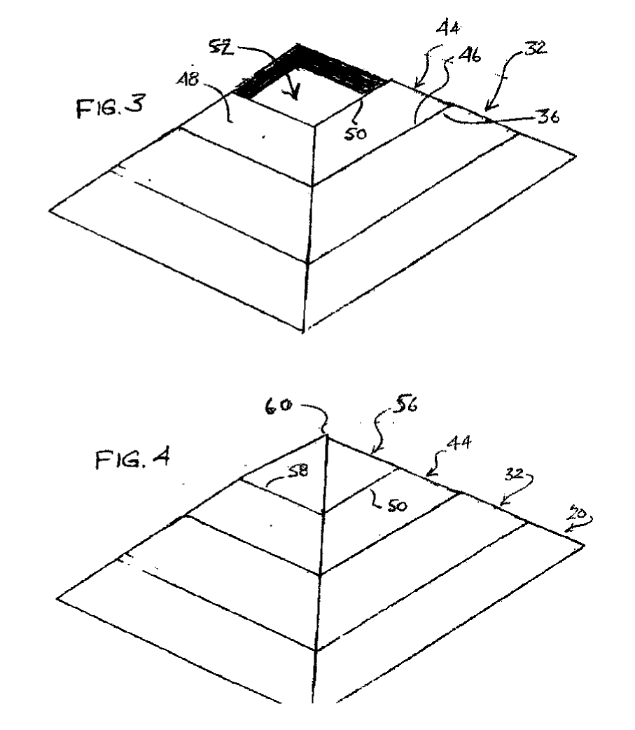

Turning to FIG. 4, there is shown a perspective view of the completed assembly of all of the sand molds needed to construct a completed pyramid shaped sand structure, the top sand mold 56 having been positioned in place atop of the third sand mold 44. The top sand mold also has a lower edge 58 that is contiguous with and preferable affixed to the upper edge 50 of the third sand mold 44 and having a closed peak 60 and thus can be filled with sand and then inverted to be placed atop of the third sand mold 44. If, of course, the upper tier of the formed sand structure has, a flat upper surface, the uppermost sand mold need not be closed as it is in FIG. 4. As such, all of the sand molds have been stacked in order to combine the individually packed tiers to produce the final shape of the pyramidal sand structure.

Turning to FIG. 5, there is illustrated a completed sand structure 62 in the form of a pyramid as desired by the user and, possibly having an object or objects located therein for the user or another player to attempt to locate by digging into the structure 62. The structure 62 of wet sand remains undisturbed after the sand molds 20, 32, 44 and 56 have been lifted vertically upwardly in the direction of the arrow A. Additionally, if the particular sand structure had an exposed or a hidden tunnel, or rooms formed by an object, the user could enjoy that feature of the sand structure.

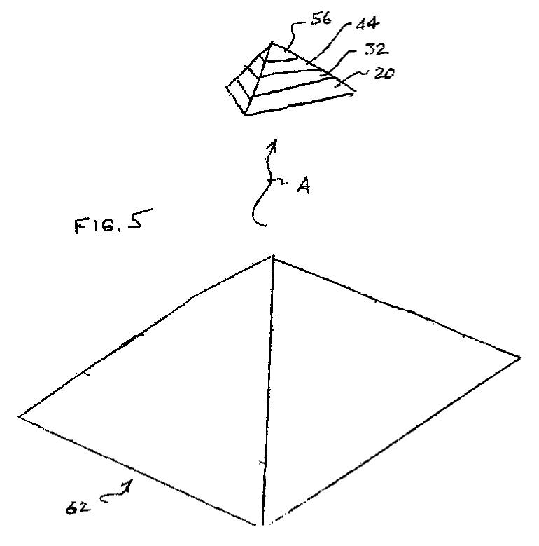

Turning now to FIG. 6, there is shown an exploded view of a system that can be used to align together two adjacent sand molds and, in the exemplary embodiment, the alignment system can be used to affix together any or all of the sand molds described in FIGS. 1-5. Thus FIG. 6 shows a cutaway segment of an upper sand mold 64 and a lower sand mold 66, each having an inside surface 65 and an outside surface 67. The upper sand mold 64 has a recess 68 with an elongated protrusion 70 that extends along, or at least partially along, the lower edge 72 of the upper sand mold 64. There is a similar recess 74 along the upper edge 76 of the lower sand mold 66 and having a elongated groove 78 disposed at least partially therealong. As such, to affix the upper sand mold 64 to the lower sand mold 66, the respective edges 72 and 76 are brought together by movement in the direction of the arrows B whereupon the elongated protrusion 70 enters into and nests within the elongated groove 78 to affix those components together.

In FIG. 7, there is an exploded view of an alternative alignment system to that of FIG. 6. In the exemplary alignment system of FIG. 7, again there is shown a cutaway segment of an upper sand mold 80 and a lower sand mold 82, each having an inside surface 81 and an outside surface 83. The upper sand mold 80 has a recess 84 forming a downwardly directed flange 86 that extends along, or at least partially along, the lower edge 88 of the upper sand mold 80. There is a similar recess 90 along the upper edge 92 of the lower sand mold 82 forming an upwardly directed flange 92 disposed at least partially therealong. As such to align the upper sand mold 80 to the lower sand mold 82, the respective edges flanges 86, 92 are brought in contact with each other, in the direction of the arrows B, to frictionally engage the upper sand mold 80 to the lower sand mold 82.

In FIG. 7A there is a still further alignment system for the upper and lower sand molds 85, 87 having inside surfaces 89 and outside surfaces 91 and wherein the upper sand mold 85 extends downwardly with an offset forming a downwardly directed flange 93 that extends over the outside surface 91 of the lower sand mold 87.

While the aforedescribed methods and devices for aligning two adjacent sand molds together are exemplary embodiments, there are certainly other ways of aligning one sand mold with another sand mold consistent with the intent and purpose of the present invention.

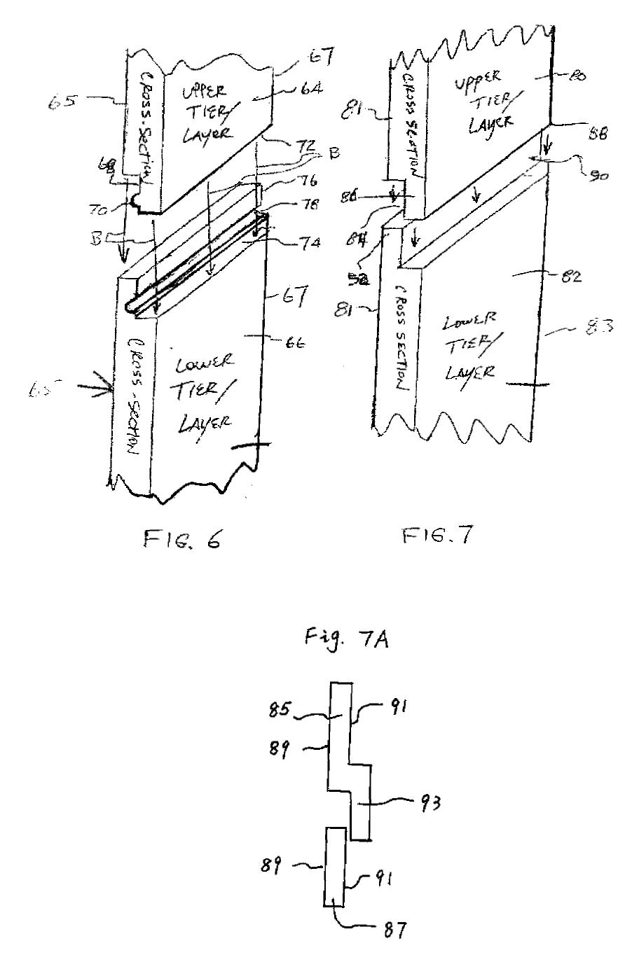

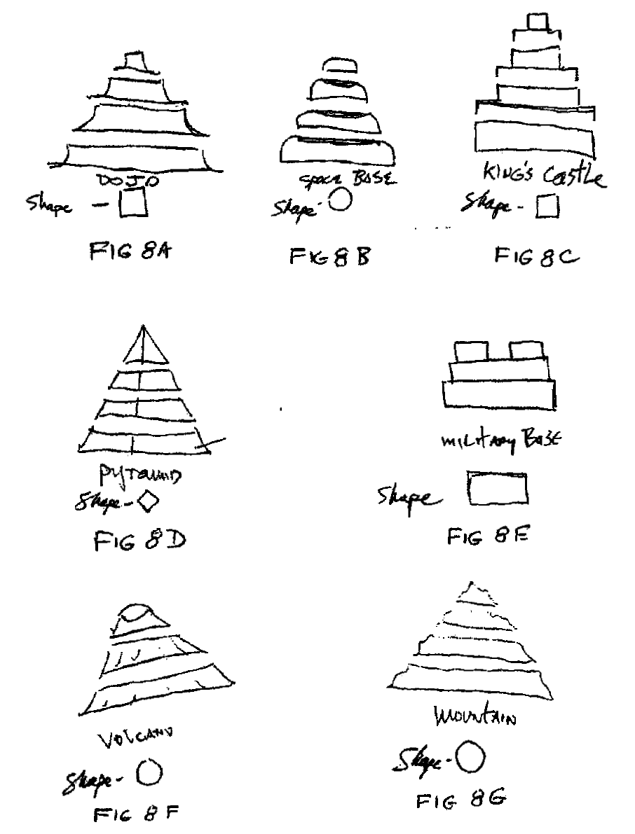

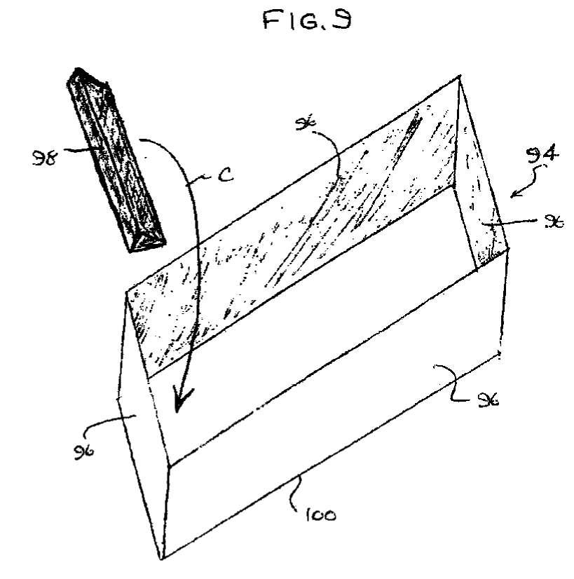

Turning to FIGS. 8A-8F there is shown a number of alternate embodiments to that of the pyramidal form illustrated in FIGS. 1-5. For example, the overall shape may have a square horizontal cross-section of FIG. 5A, a circular horizontal cross section as show in FIG. 8B, a castle shape having a square horizontal cross section of FIG. 8C, the pyramid shape of FIG. 8D, a rectangular shape as shown in FIG. 8E, a circular “volcano” shape of FIG. 8F and a mountain shape of FIG. 8G. Again, the shapes and configurations of FIGS. 8A-8G are only a few of a wide variety of differing shapes that can be used with the sand molds of the present invention to create a wide variety of sand structures.

Turning now to FIG. 9, there is a further feature of the present invention. With the embodiments wherein the perimeter of the upper edge of the sand mold is smaller than the perimeter of the lower edge of the sand mold, it is relatively easy to remove the tiered sand molds vertically upwardly, however, there are instances wherein the perimeters may be the same or where it is desired to have a sand structure wherein the lower portions or perimeters of the sand structure are smaller than or undercut with respect to the upper portions or perimeters.

Accordingly, there can be used void blocks that can be placed into a sand mold along the inside wall thereof to create a void in the sand structure.

Turning, therefore, to FIG. 9, there is a perspective view of a sand mold 94 having sides 96 that are relatively vertical and thus there is a void block 98 that can be inserted into the sand mold 94 and positioned at a lower edge 100 thereof in accordance with the arrow C. As such, the cross section of the void block 98 is triangular, however, other cross sectionals shapes could be utilized consistent with the intent of the present invention. Also, the void block can be placed in any one or more of the tiers and there may be multiple void blocks located in a single tier such as where the void blocks operate in tandem or form differing voids in that single tier.

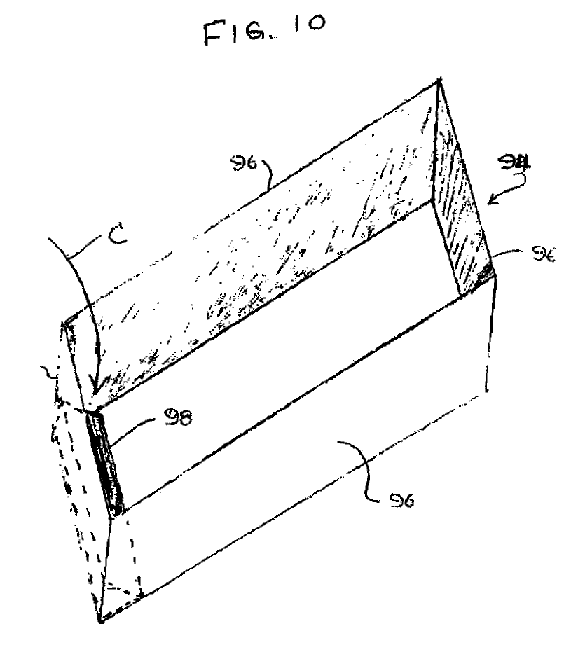

Turning to FIG. 10, taken also with FIG. 9, the void block 98 is shown in the desired position at the lower edge of the sand mold 94. Thus, when the sand mold 94 is filled with sand, there is a void that is created in the sand structure in the shape of the void block 98.

In FIG. 11, there can be seen that the sand mold 94 has been removed by being displaced upwardly in accordance with arrows D, with the void block 98 still in place creating the void in the sand structure 102.

In FIGS. 12 and 12A, there is an exploded view and a side view, respectively, of the sand structure 102 where the void block 98 has been removed by removing it laterally in the direction of the arrows E, leaving a void 104 in the shape of the void block 98. A void block can, therefore be formed in a wide variety of shapes and sizes to create a desired sand structure.

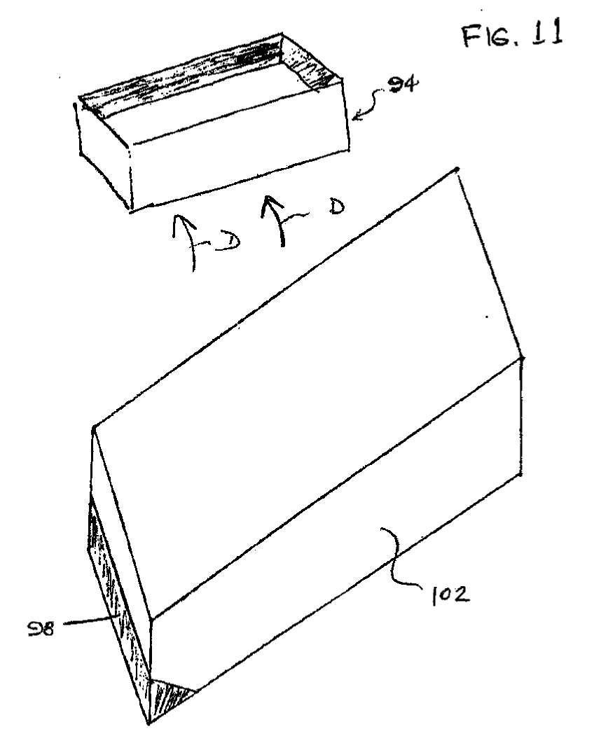

For example, in FIG. 13, there is shown a plurality of sand molds 106, 108 and 110 that have been progressively filled with sand in accordance with the present invention. As can be seen, the void block 112 of the FIG. 13 embodiment is a saucer shape such that the lower surface of the ultimate sand structure has a rounded undersurface and which may be curved in a variety of curvatures, including a spherical undersurface.

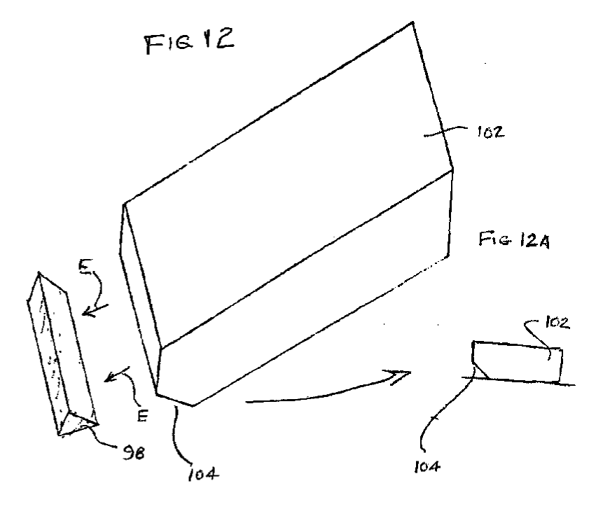

In FIG. 14, there is a shown a plurality of sand molds 114, 116 and 118 that are used to create a sand structure in the shape of a battleship by the use of lateral void blocks 120. In FIG. 15, the plurality of sand molds 122, 124, 126, 128, 130 and 132 each have void blocks 134, 136, 138, 140 and 142 in order to a sand structure in the form of a building or other similar structure. The void blocks in FIG. 15 can be one larger void block of may be multiple void blocks arranged side by side, atop of one another vertically, on either side or pieced together to create the desired sand structure.

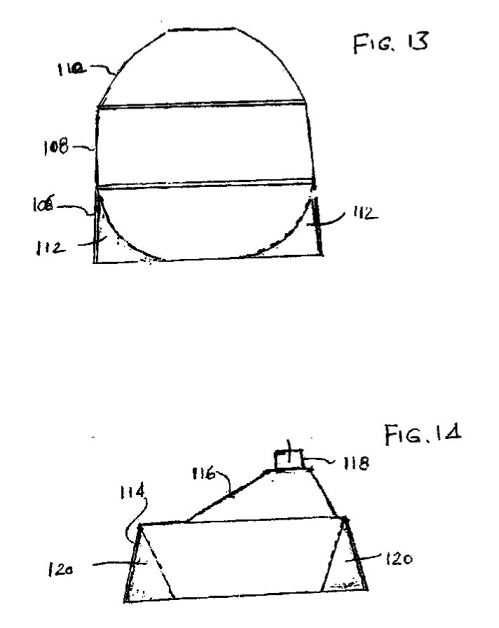

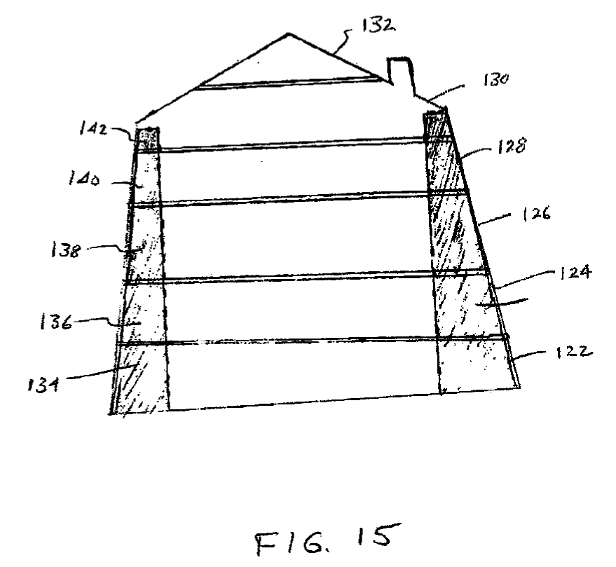

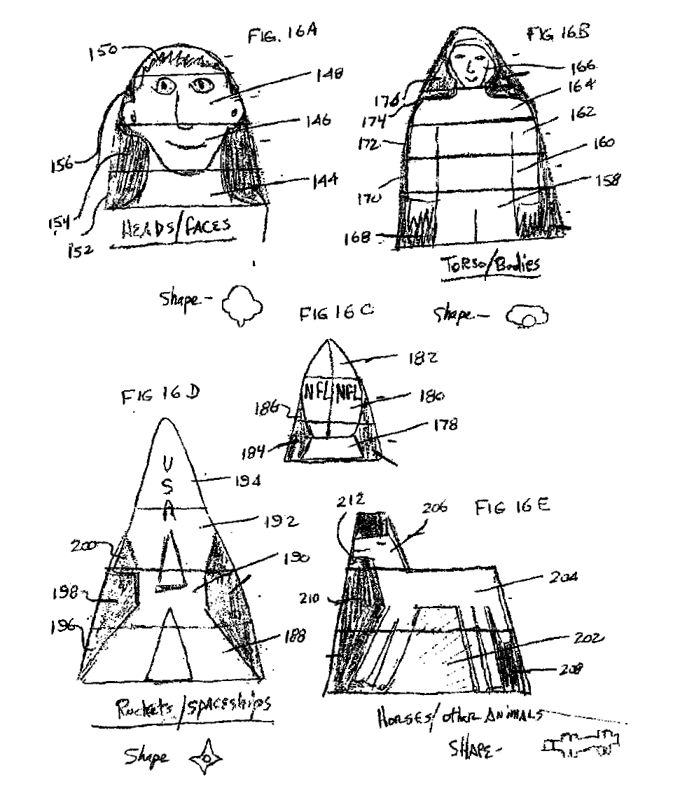

Turning to FIGS. 16A-16E there is shown a number of further illustrative alternate sand structures that can be created with the use of void blocks in carrying out the present invention. In each instance the void block is illustrated still in place on the sand structure, that is, prior to the void block being removed from that structure in order to illustrate the location of the void block.

Accordingly, in FIG. 16A, there is shown a plurality of tiers formed by sand molds 144, 146, 148 and 150 to create the shape of a head and face by the use of lateral void blocks 152, 154 and 156. In FIG. 16B, the particular shape of the sand structure is of a torso or body and which is formed by sand molds 158, 160, 162, 164 and 166 through the use of void blocks 168, 170, 172, 174 and 176. FIG. 16C shows the shape of a sporting device such as a football and which is formed in tiers by sand molds 178, 180 and 182 along with void blocks 184 and 186.

Next, in FIG. 16D, there is a sand structure in the shape of a rocket or spaceship and formed by sand molds 188, 190, 192 and 194 and the use of void blocks 196, 198 and 200 and in FIG. 16E, there is a sand structure in the shape of a horse or other animal and formed by sand molds 202, 204 and 204 and with the use of void blocks 206, 208 and 210.

In the use of the present invention, a plurality of sand molds can be provided to a purchaser in a single package such that the package of the tools would include at least one of the sand molds along with one or more void blocks that can be used with the sand molds in that package to create a particular shape of sand structure.

Therefore, the user can purchase a particular package containing the necessary sand molds and void blocks that the user can employ in accordance with the method of the present invention to construct, for example, a castle, a pyramid, a building, a battleship or other sand structure desired by the purchaser along with a weapon or weapons that can be used by a user or other child to destroy the structure constructed by the use of the sand mold and void blocks. Preferably, the package also contains instructions to the purchaser as to how to use the sand molds and void blocks contained within the package to construct the particular sand structure illustrated on the package as well as the sand molds, void blocks, discovery objects and weapons.

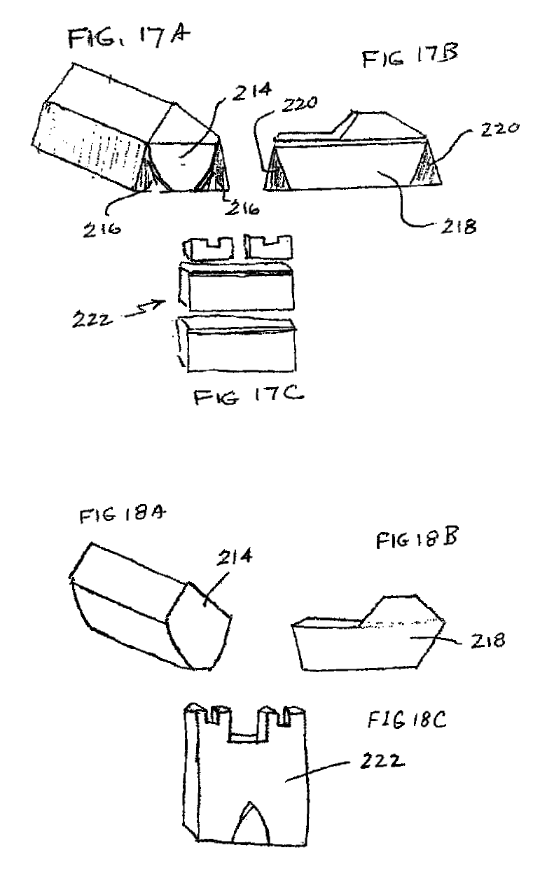

As an example of the contents of some of the aforedescribed packages, there is shown in FIGS. 17A-17C a few typical shapes of sand molds and sand structures that can be constructed therefrom and which are enjoyable to play with and to possibly destroy. As such, in FIG. 17A there is a sand submarine 214 with void blocks 216, in FIG. 17B, there is a ship 218 with void blocks 220 and in FIG. 17C there is a castle 222. The completed submarine 214, ship 218 and castle 222 is illustrated in FIGS. 18A-18C, respectively. Again as explained, the sand structures shown in FIG. 18A-18C are but exemplary embodiments and any number of other sand structures could be constructed by the sand molds contained within a particular package.

As a part of a game that can be played with the sand structures of FIGS. 18A-18C there can be provided to the user a weapon and that weapon can include those illustrated in FIGS. 19A-C, that is, toy simulated bombs 224, a toy gun 226 or a toy cannon 228 and one or all of those weapons can be supplied to the user to carry out the game along with any number of other weapons that would be enjoyable for use by a child in destroying a sand structure.

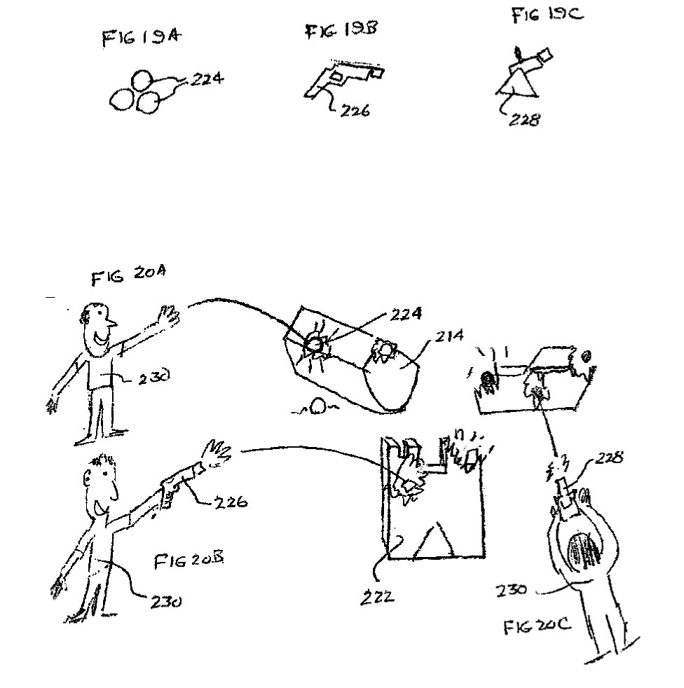

Finally, in accordance with the game, there is shown in FIGS. 20A-20C, schematic views of a user 230 using each of the weapons illustrated in FIGS. 19A-19C, to destroy the submarine 214, the ship 218 and the castle 222.

Accordingly, the particular package can be sold to the user containing all of the necessary tools to carry out the game in constructing a sand structure as well as the weapons that can cause the destruction of that sand structure.

Those skilled in the art will readily recognize numerous adaptations and modifications which can be made to the system of constructing sand structures and packages of tools to construct sand structures of the present invention which will result in an improved system and package, yet all of which will fall within the scope and spirit of the present invention as defined in the following claims. Accordingly, the invention is to be limited only by the following claims and their equivalents.

What is claimed is:

1. A system for producing a structure, said system comprising at least first and second molds, each of said molds having a perimeter with an open area within the perimeter, each mold having an upper edge and a lower edge, and wherein a second mold is adapted to be positioned atop of a first mold.

2. The system of claim 1 wherein the structure is a sand structure and the at least first and second molds are sand molds.

3. The system of claim 2 wherein the lower edge of the second sand mold is adapted to be contiguous to the upper edge of the first sand mold when located atop of the first sand mold.

4. The system of claim 2 wherein the lower edge of the second sand mold is adapted to be aligned to the upper edge of the first sand mold when located atop of the first sand mold.

5. The system of claim 1 further including an alignment device to align the lower edge of the second sand mold to the upper edge of the first sand mold.

6. The system of claim 5 wherein the alignment device comprises a groove formed either the lower edge of the second sand mold or the upper edge of the first sand mold and an elongated protrusion along either the upper edge of the first sand mold or the lower edge of the second sand mold, said protrusion adapted to interlock with said elongated groove.

7. The system of claim 5 wherein the alignment device comprises a flange formed in the perimeter of one of the sand molds and an overlapping flange formed in the perimeter of the other sand mold and wherein the flanges are adapted to be interfitted together to frictional engage each other.

8. The system of claim 1 wherein the system further includes a void block adapted to be located at or proximate to an inner lower edge of one or both of the at least first and second sand molds.

9. A system for producing a structure, said system comprising at least one mold having a perimeter with an open area within the perimeter, the at least one mold having an upper edge and a lower edge, and at least one void block adapted to be positioned proximate to an inner edge of the at least one mold to prevent material from occupying the space taken up by the at least one void block when the at least one mold is filled with material.

10. The system of claim 9 wherein the at least one mold is a sand mold and the material is sand.

11. The system of claim 10 wherein the system comprises a plurality of sand molds for forming sand tiers and the at least one void block comprises at least one void block adapted to be located in at least one of the sand tiers.

12. The system of claim 11 wherein the system comprises a plurality of void blocks located in at least one of the sand tiers.

13. The system of claim 10 wherein the system includes objects adapted to be located within or at least partially within the at least one mold.

14. A package of sand molding tools for constructing a sand structure, the package comprising:
at least one sand mold, the at least one sand mold forming a perimeter with an open area within the perimeter, the at least one sand mold having an upper edge and a lower edge, the package further containing at least one void block adapted to be located within the at least one sand mold to prevent sand from filling the space occupied by the at least one void block.

15. The package of sand molding tools as defined in claim 14 wherein the package contains a plurality of sand molds wherein one of the sand molds is adapted to be positioned atop of another sand mold.

16. The package of sand molding tools as defined in claim 15 wherein the upper edge of one of the sand molds can be aligned to the lower edge of another sand mold and wherein the respective mating edges are generally contiguous to each other when aligned together.

17. The package of sand molding tools as defined in claim 14 wherein the package contains selected sand molds and void blocks designed to construct at least one particular shape of sand structure.

18. The package of sand molding tools as defined in claim 14 wherein the package includes at least one weapon that is adapted to be used to destroy a sand structure constructed by the use of a sand mold.

19. The package of sand molding tools as defined in claim 18 wherein the at least one weapon includes a weapon selected from the group consisting of toy bombs, toy guns and toy cannons.

20. The package of sand molding tools as defined in claim 14 wherein the package includes at least one object adapted to be located within or at least partially within the at least one sand mold.
